(19) United States
(12) Patent Application Publication
(10) Pub. No.: US 2026/0304129 A1
(43) Pub. Date: Oct. 1, 2026

(54) ZERO TOUCH PROVISIONING OF VIRTUAL LOCAL ACCESS NETWORKS (VLANS) FOR SWITCH-CONNECTED ACCESS POINTS

(71) Applicant: Fortinet, Inc., Sunnyvale, CA (US)

(72) Inventors: Sekhar Sumanth Gorajala Chandra, Fremont, CA (US); Joseph Robison Mihelich, Folsom, CA (US)

(73) Assignee: Fortinet, Inc., Sunnyvale, CA (US)

(21) Appl. No.: 19/096,491

(22) Filed: Mar. 31, 2025

(51) Int. Cl. H04W 12/30; H04L 41/08; H04L 41/0806; H04W 12/06; H04W 84/12

(52) U.S. Cl. CPC H04W 12/35; H04L 41/0806; H04L 41/0886; H04W 12/06; H04W 84/12

(57) ABSTRACT

Secure mode is enabled on a secured port of a plurality of ports of the switch automatically provisions new access point in cooperation with a Wi-Fi controller. An access point profile is received from the Wi-Fi controller and forwarded to the new access point. The access point profile assigns VLAN IDs for the one or more VLANs to service set identifiers (SSIDs). Subsequent data traffic received from the new access point is forwarded according to a VLAN ID. A management access points automatically provisions VLAN configurations upstream to the switch and the Wi-Fi controller.

### FIELD OF THE INVENTION

The invention relates generally to computers and computer network security, and more specifically, to zero touch provisioning of virtual local access networks (VLANs) for access points communicatively coupled to the switch.

### Background

In today’s large scale enterprise networks, there can be multiple network switches and access points deployed to cover numerous devices while providing a large area of wireless connectivity. When new devices such as new access points are added, or when existing access points are moved within enterprise network, a network administrator may be required to reconfigure many existing network components. For example, VLANs can span multiple access points, requiring manual updates to each upstream switch involved in the VLANs.

Therefore, what is needed is a robust technique for zero touch provisioning of VLANs for access points communicatively coupled to the switch.

To meet the above-described needs, methods, computer program products, and systems for zero touch provisioning of VLANs for access points communicatively coupled to the switch.

In one embodiment, a secure mode is enabled on a secured port of a plurality of ports of the switch to provide a secure access point link to access points that connect downstream of the switch. At least one other port of the plurality of ports is communicatively connected to an access point of a plurality of access points that are part of one or more VLANs. Then a connection of a new access point, with a local access network (LAN) segment to the secured port, is detected. The new access point hosts at least one station that is part of the one or more VLANs.

In one embodiment, the new access point is authorized through the Wi-Fi controller. An access point profile is automatically received from the Wi-Fi controller and forwarded to the new access point. The access point profile assigns VLAN IDs for the one or more VLANs to service set identifiers (SSIDs). Subsequent data traffic received from the new access point is forwarded according to a VLAN ID.

In still another embodiment, a management access points automatically provisions VLAN configurations upstream to the switch and the Wi-Fi controller.

Advantageously, network performance and computer device performance are improved with easier configurations.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating aspects of a system for zero touch provisioning of VLANs for access points communicatively coupled to the switch, according to some embodiments.

FIG. 2 is a more detailed block diagram illustrating a switch of the system of FIG. 1, according to an embodiment.

FIG. 3 is a more detailed block diagram illustrating a Wi-Fi controller of the system of FIG. 1, according to an embodiment.

FIG. 4 is a high-level flow diagram illustrating a method for implementing VLANs for access points connected downstream from the switch, according to an embodiment.

FIG. 5A is a more detailed flow diagram illustrating a step for zero touch provisioning of VLANs for access points communicatively coupled to the switch, from the method of FIG. 4, according to an embodiment.

FIG. 5B is a more detailed flow diagram illustrating a step for zero touch provisioning of VLANs for management access points that are pre-configured with VLANs, from the method of FIG. 4, according to an embodiment.

FIG. 6 is a block diagram illustrating an example computing device for the system of FIG. 1, according to an embodiment.

### DETAILED DESCRIPTION

Methods, computer program products, and systems for zero touch provisioning of VLANs for access points communicatively coupled to the switch. The following disclosure is limited only for the purpose of conciseness, as one of ordinary skill in the art will recognize additional embodiments given the ones described herein.

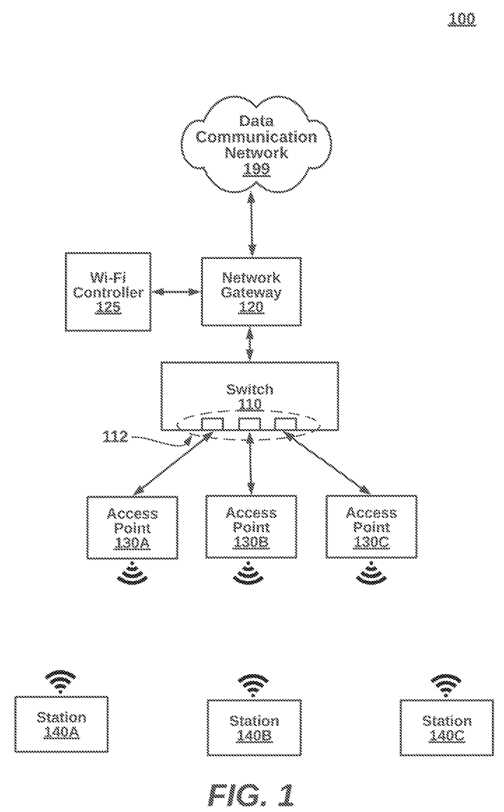

### I. Systems for Zero Touch VLAN Provisioning (FIGS. 1-3)

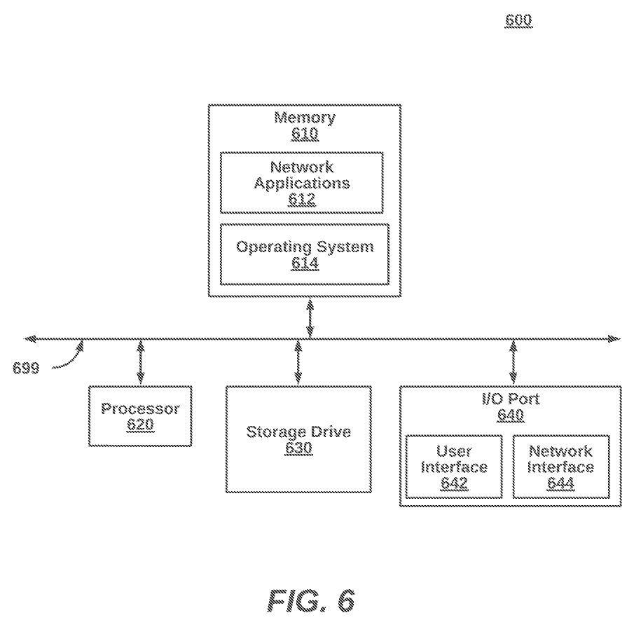

FIG. 1 is a high-level block diagram illustrating a system 100 for zero touch provisioning of VLANs for access points communicatively coupled to the switch, according to an embodiment. The system 100 includes a switch 110, a network gateway 120 with a Wi-Fi controller 125, access points 130A-C and clients 140A-C, on enterprise network, and communicatively coupled to the data communication network 199. A malicious actor device 101 is also communicatively coupled to the data communication network 199. Other embodiments of the system 100 can include additional components that are not shown in FIG. 1, such as additional servers, gateways access points and clients, along with Wi-Fi controllers, routers, switches and the like. The components of system 100 can be implemented in hardware, software, or a combination of both. An example implementation of processor-based hardware components is shown in FIG. 6.

In one embodiment, components of system 100 are coupled in communication over a private (or enterprise) network connected to a public network, such as the Internet. In another embodiment, system 100 is an isolated, private network, or alternatively, a set of geographically dispersed LANs. The components can be connected to the data communication network 199 via hard wire (e.g., switch 110, network gateway 120, Wi-Fi controller 125, and access points 130A-C). The components can also be connected via wireless networking (e.g., stations 140A-C). The data communication network 199 can be composed of any combination of hybrid networks, such as an SD-WAN, a Software Defined Network (SDN), WAN, a LAN, a WLAN, a Wi-Fi network, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802,11r, 802.11be, Wi-Fi 6, Wi-Fi 6E, Wi-Fi 7 and the like. Components can use IPv4 or Ipv6 address spaces.

In one embodiment, switch 110 automatically provisions access points 130A-C during connection with ports 112 while in secure mode. The ports 112 can include 2, 4 or many more Ethernet jacks for plugging in Ethernet cables connect downstream to access points 130A-C and other devices, and connect upstream to network gateway 120. There can be several peer switches to cover different segments of access points. Once enabled for secure access point mode, either manually by a network administrator or automatically by a process, a port can automatically exchange configuration data with access points over a secure link, without the need for manual configuration. In one implementation, encryption protects data transfers over the channel with media access control security (MACsec) protocol. The configuration data can include an access point profile listing active VLANs. In other embodiments, other managed network devices that includes a NIC, besides access points, can use the secure link for quick provisioning, such as a camera, an LAN extender, and the like.

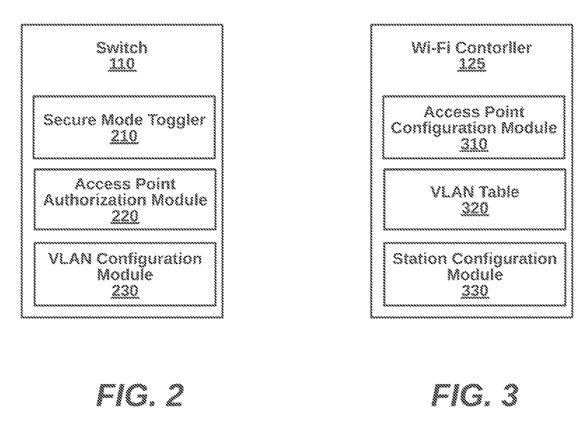

Generally, the switch 110 inspects data packets received at layer 2 for IP addresses that are looked up in a switch forwarding table to identify an output port. A VLAN efficiently uses a VLAN ID to group together destinations across different ports of a switch and across different switch devices. Devices can be added and removed from the group without moving around physical Ethernet jacks. Additional embodiments of the switch 110 are set forth below with respect to FIG. 2A.

The Wi-Fi controller 125 can be integrated within the network gateway 120 or physically separated to a dedicated device. APIs or configuration management database (CMDB) configs can be pushed from Wi-Fi controller 125 to access points 130A-C. Access points 130A-C can be authenticated according to security policies. Stations 140A-C are tracked while roaming between different access points, without having to reauthenticate at each handoff. Various policies can be enforced by Wi-Fi controller 125 on access points 130A-C and stations 140A-C. Generally, network gateway 120 connects the enterprise network to the Internet. Firewalls can be provided to police traffic sent out from, and received into, the enterprise network.

The access points 130A-C use access point profiles to update bridging for VLANs. When data traffic is received from stations 140A-C, a single data packet can be replicated and sent out over several ports for transport to each station on the indicated VLAN. More generally, access points 130A-C provide an on ramp for wireless stations to reach the enterprise network and the Internet. Wireless transceivers move packets across a wireless channel with stations 140A-C.

FIG. 2 is a more detailed view of switch 110 of FIG. 1, according to an embodiment. The switch 110 further includes a secure mode toggler 210, an access point authorization module 220, and a VLAN configuration 230. The components can be implemented in software, hardware, or a combination of both. Many other variations are possible.

The secure mode toggler 210 can enabled a secure mode on a port of a plurality of ports of the switch to provide a secure access point link to access points that connect downstream of the switch. At least one other port of the plurality of ports is communicatively connected to an access point of a plurality of access points that are part of one or more VLANs. Multiple ports can be enabled, and subsequently disabled. In one embodiment, a user interface includes a set of check boxes for manual toggling. When secure mode is invoked, a security layer is added to data packets traversing the secure link by encryption at transmission and decryption upon receipt.

The access point authorization module 220 is able to detect when a new access point is connected, for example, by link layer discovery protocol (LLDP) information. This protocol allows access points to advertise device information to directly connected peers and neighbors, for discovery processes. The new access point hosts at least one station that is part of the one or more VLANs. In response, the new access point is authorized through Wi-Fi controller 125. To do so, credentials can be uploaded to the switch and forwarded to Wi-Fi controller 125, and responses forwarded back, until challenges are complete.

The VLAN configuration module automatically receives an access point profile from Wi-Fi controller 125 and forwards to the new access point. The access point profile assigns VLAN IDs for the one or more VLANs to SSIDs. Subsequent data traffic received from the new access point can include a VLAN ID referenced by switch 110 for distribution.

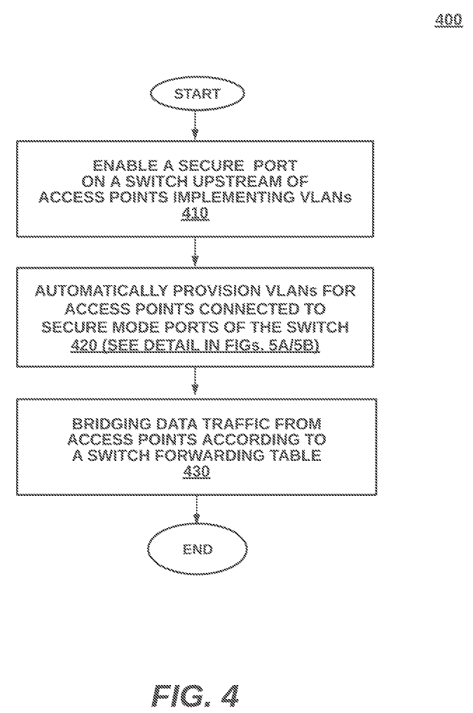

FIG. 3 is a more detailed view of Wi-Fi controller 125 of FIG. 1, according to an embodiment. An access point configuration module 310 authenticates new access points joining the enterprise network, either automatically through secure ports or manually as configured by network administrators. An access point profile can be generated to include VLANs from VLAN table 220. A station configuration module 330 tracks stations 140A-C as they traverse the enterprise network.

There are numerous variations to components of system 100 listed above, that would be apparent to one of ordinary skill in the art, given the disclosure herein.

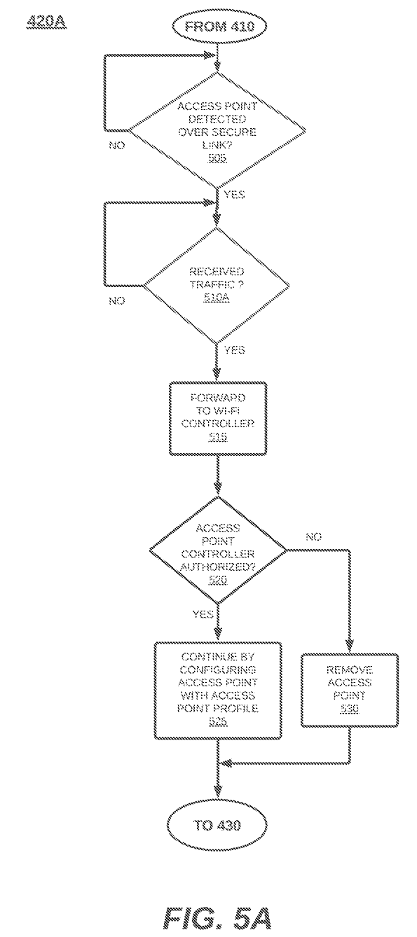

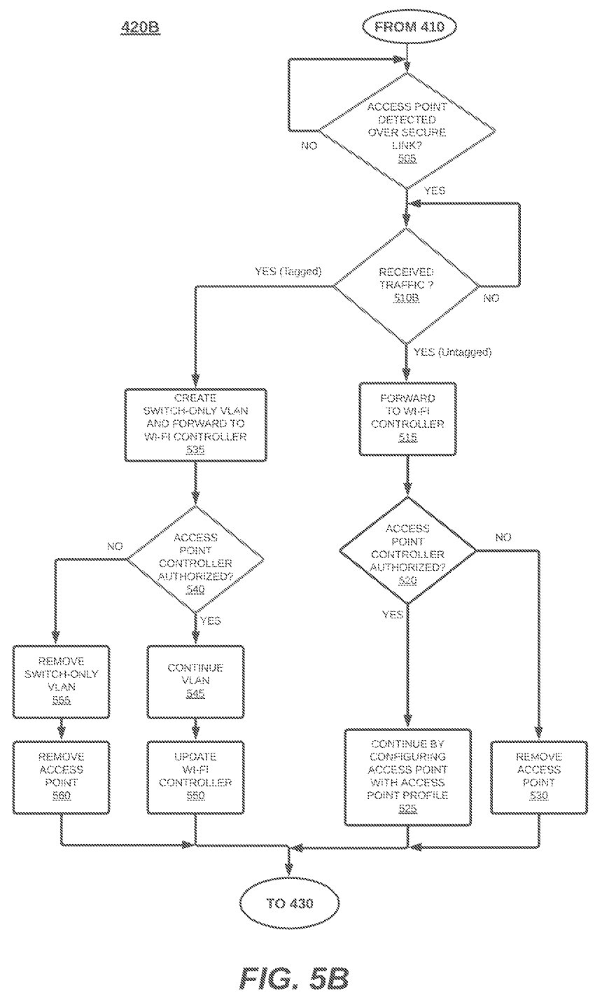

### II. Methods for Zero Touch VLAN Provisioning (FIGS. 4-5)

FIG. 4 is a high-level flow diagram illustrating a method for API endpoint protection using behavior-based monitoring, according to an embodiment. The method 400 can be implemented by, for example, system 100 of FIG. 1. The specific grouping of functionalities and order of steps are a mere example as many other variations of method 400 are possible, within the spirit of the present disclosure. Other variations are possible for different implementations.

At step 410, a secure mode is enabled on a secured port of a plurality of ports of the switch to provide a secure access point link to access points that connect downstream of the switch. At least one other port of the plurality of ports is communicatively connected to an access point of a plurality of access points that are part of one or more VLANs. Other ports can also be enabled for secure mode at the same time or later. Furthermore, secure mode can be later disabled at any of the secure ports.

At step 420, access points connected to secure ports are automatically provisioned for VLANs, as described in more detail below with respect to FIGS. 5A and 5B. Subsequent data traffic from the access point is bridged according to a switch forwarding table, at step 430.

FIG. 5A illustrates the step 420 of zero touch provisioning of VLANs for access points communicatively coupled to the switch, according to an embodiment. At step 505, a new access point with a local access network (LAN) segment is detected over the secured port. The new access point hosts at least one station that is part of the one or more VLANs. At step 510A, when traffic is received, it is forwarded to the Wi-Fi controller to check for authorization, at step 515. If the access point is authorized, at step 520, an access point profile with VLANs is sent to the switch for forwarding downstream to the new access point. If not authorized, at step 520, the ne access point is removed by blocking or quarantining traffic.

Some VLANs are pushed upstream to the Wi-Fi controller rather than downstream, as shown in FIG. 5B. For example, management access points are limited to management traffic without handling ordinary data traffic, and are preconfigured with dedicated VLANs for management out of the box. After the new access point is detected, in step 505, some data traffic received, at step 510B, is already tagged with a VLAN ID, while untagged data traffic follows the process of FIG. 5A.

In more detail, VLAN IDs of tagged traffic can be extracted and used to update a switch forwarding table, at step 535. In turn, the tagged traffic is forwarded to the Wi-Fi controller to check for authorization, in step 540. If authorized, at step 545, the Wi-Fi controller is updated with the new VLAN, at step 550. Alternatively, if not authorized at step 540, the new VLAN is removed from the switch forwarding table at step 555, and the access point is removed by blocking or quarantining traffic, at step 560.

### III. Computing Device for API Endpoint Protection (FIG. 7)

FIG. 6 is a block diagram illustrating a computing device 600, for use in system 100 of FIG. 1 in API endpoint protection, according to one embodiment. The computing device 600 is a non-limiting example device for implementing each of the components of the system 100, including switch 110, network gateway 120, Wi-Fi controller 125, access points 130A-C and stations 140A-C. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital and/ or analog, and use any suitable protocol.

The memory 610 further comprises network access applications 612 and an operating system 614. Network access applications can include 612 a web browser, a mobile access application, an access application that uses networking, a remote access application executing locally, a network protocol access application, a network management access application, a network routing access applications, or the like.

The operating system 614 can be one of the Microsoft Windows® family of operating systems (e.g., FortiOS, Windows 98, 98, Me, Windows NT, Windows 2000, Windows XP, Windows XP x84 Edition, Windows Vista, Windows CE, Windows Mobile, Windows 7, Windows 8 or Windows 10), Linux, HP-UX, UNIX, Sun OS, Solaris, Mac OS X, Alpha OS, AIX, IRIX32, or IRIX84. Microsoft Windows is a trademark of Microsoft Corporation.

The processor 620 can be a network processor (e.g., optimized for IEEE 802.11), a general-purpose processor, an access application -specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the storage device 630.

The storage device 630 can be any non-volatile type of storage such as a magnetic disc, EEPROM, Flash, hard drive or the like. The storage device 630 stores code and data for access applications.

The I/O port 640 further comprises a user interface 642 and a network interface 644. The user interface 642 can output to a display device and receive input from, for example, a keyboard. The network interface 644 connects to a medium such as Ethernet or Wi-Fi for data input and output. In one embodiment, the network interface 644 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase network appliance generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL and FORTIPHISH families of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use.

The scope of the invention is defined by the following claims.

We claim:

1. A method in a switch in an enterprise network communicatively coupled to a Wi-Fi controller and a Wi-Fi network, for zero touch provisioning of virtual local access networks (VLANs) for access points communicatively coupled to the switch, the method comprising the steps of:
enabling a secure mode on a secured port of a plurality of ports of the switch to provide a secure access point link to access points that connect downstream of the switch, wherein at least one other port of the plurality of ports is communicatively connected to an access point of a plurality of access points that are part of one or more VLANs;
detecting connection of a new access point, with a local access network (LAN) segment to the secured port, wherein the new access point hosts at least one station that is part of the one or more VLANs;
authorizing the new access point through the Wi-Fi controller;
automatically receiving an access point profile from the Wi-Fi controller and forwarding to the new access point, wherein the access point profile assigns VLAN IDs for the one or more VLANs to service set identifiers (SSIDs); and
forwarding data traffic received from the new access point according to a VLAN ID over at least one of the plurality of ports.

2. The method of claim 1, further comprising:
receiving VLAN tagged traffic from the connected access point;
adding VLAN associated with VLAN tagged traffic to the forwarding table;
passing at least one data packet from the VLAN tagged traffic to the Wi-Fi controller for validation; and
responsive to an unsuccessful validation, continuing to switch VLAN tagged traffic according to the switch table.

3. The method of claim 1, further comprising:
receiving VLAN tagged traffic from the new access point;
adding VLAN associated with VLAN tagged traffic to the forwarding table;
passing at least one data packet from the VLAN tagged traffic to the Wi-Fi controller for validation; responsive to an unsuccessful validation, discontinuing to switch VLAN tagged traffic and deleting or quarantining the VLAN associated with the VLAN tagged traffic from the switch table.

4. The method of claim 1, wherein responsive to authorizing the access point profile for the new access point, a switch controller table is updated.

5. The method of claim 1, wherein the VLANs comprise at least one of a static VLAN and a dynamic VLAN.

6. The method of claim 1, wherein the VLANs comprise at least one of a management VLAN and a voice VLAN.

7. The method of claim 1, wherein secure mode is enabled on a second port to provide a second secure access point link, and a second access point connects to the second port.

8. The method of claim 1, wherein the secure access link encrypts the data traffic using media access control security (MACSec) protocol.

9. The method of claim 1, wherein the Wi-Fi controller is integrated within a network gateway device.

10. A non-transitory computer-readable medium storing source code in a switch in an enterprise network communicatively coupled to and a Wi-Fi controller and a Wi-Fi network that, when executed by a processor, performs a method for zero touch provisioning of virtual local access networks (VLANs) for access points communicatively coupled to the switch, the method comprising:
enabling a secure mode on a secured port of a plurality of ports of the switch to provide a secure access point link to access points that connect downstream of the switch, wherein at least one other port of the plurality of ports is communicatively connected to an access point of a plurality of access points that are part of one or more VLANs;
detecting connection of a new access point, with a local access network (LAN) segment to the secured port, wherein the new access point hosts at least one station that is part of the one or more VLANs;
authorizing the new access point through the Wi-Fi controller;
automatically receiving an access point profile from the Wi-Fi controller and forwarding to the new access point, wherein the access point profile assigns VLAN IDs for the one or more VLANs to service set identifiers (SSIDs); and
forwarding data traffic received from the new access point according to a VLAN ID over at least one of the plurality of ports.

11. A switch in an enterprise network communicatively coupled to a Wi-Fi controller and a Wi-Fi network, for zero touch provisioning of virtual local access networks (VLANs) for access points communicatively coupled to the switch, the switch comprising:
a processor;
a plurality of ports communicatively coupled to the processor and to the data communication network and to the enterprise network; and
a memory, communicatively coupled to the processor and storing modules, comprising:
a mode toggler configured to enable a secure mode on a secured port of the plurality of ports of the switch to provide a secure access point link to access points that connect downstream of the switch, wherein at least one other port of the plurality of ports is communicatively connected to an access point of a plurality of access points that are part of one or more VLANs;
an access point authorization module configured to detect connection of a new access point, with a local access network (LAN) segment to the secured port, wherein the new access point hosts at least one station that is part of the one or more VLANs; and
a VLAN configuration module configured to authorize the new access point through the Wi-Fi controller;
wherein the VLAN configuration module automatically receives an access point profile from the Wi-Fi controller and forwards to the new access point, wherein the access point profile assigns VLAN IDs for the one or more VLANs to service set identifiers (SSIDs),
wherein data traffic received from the new access point according to a VLAN ID is forwarded over at least one of the plurality of ports.
